(19) United States
(12) Patent Application Publication
(10) Pub. No.: US 2018/0223649 A1
(43) Pub. Date: Aug. 9, 2018

(54) METHODS AND SYSTEMS USING MICRO-PHOTOMULTIPLIER TUBES AND MICROFLUIDICS WITH INTEGRATED COMPUTATIONAL ELEMENTS

(71) Applicant: Halliburton Energy Services, Inc., Houston, TX (US)

(72) Inventors: David L. PERKINS, The Woodlands, TX (US); Robert S. ATKINSON, Conroe, TX (US); Michael T. PELLETIER, Houston, TX (US)

(21) Appl. No.: 15/506,716

(22) PCT Filed: Oct. 6, 2015
(86) PCT No.: PCT/US2015/054126

§ 371 Date: Feb. 24, 2017

(51) Int. Cl. E21B 47/10; B01L 3/00; E21B 49/08

(52) U.S. Cl. CPC E21B 47/102; B01L 3/502715; B01L 2300/168; B01L 2300/0654; E21B 49/08

(57) ABSTRACT

A microfluidic optical computing device having a microfluidic layer including a microfluidic channel that receives a portion of a sample, and a method for using it are provided. The device includes one light source to interact with the portion of the sample in the microfluidic channel to generate a sample interacted light. The device may also include an integrated computational element (ICE) layer including an ICE core, to generate a modified light from the sample interacted light, and a detector layer configured to measure an intensity of the modified light and to generate an output signal corresponding to a characteristic of the sample.

### BACKGROUND

Microfluidic chips in use today typically involve the handling and measurement of small portions of a sample, thus demanding high sensitivity and low photon counting techniques and photodetectors. To achieve low photon counting measurements with high Signal-to-Noise Ratio (SNR), the photodetector of choice in the prior art is commonly a photomultiplier tube (PMT). Current systems using photomultiplier tubes tend to be bulky and have cumbersome geometries due to the large dimension of high voltage cascading vacuum chambers associated with the photosensitive element. Furthermore, the requirement of multiple miniaturized optical filters and other spectroscopic devices desirable for a full measurement suit hinders the ability for multiplexing measurements in microfluidic chips available today.

### BRIEF DESCRIPTION OP THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates a block diagram of a system for measuring a characteristic of a sample using a microfluidic optical computing device.

FIG. 2 illustrates a cross-sectional view of an integrated computational element including an input light and an output light in a microfluidic optical computing device.

FIG. 3A illustrates an exemplary microfluidic optical computing device including a light source layer, a microfluidic layer, an ICE layer, and a detector layer.

FIG. 3B illustrates a cross-sectional view of a microfluidic optical computing device as illustrated in FIG. 3A.

FIG. 3C illustrates a cross-sectional view of a microfluidic optical computing device as illustrated in FIG. 3A.

FIG. 4 illustrates a detector in a microfluidic optical computing device.

FIG. 5 illustrates a drilling system configured to use an optical sensor including a microfluidic optical computing device in a measurement-while-drilling (MWD) and a logging-while-drilling (LWD) operation.

FIG. 6 illustrates a wireline system configured to use an optical sensor including a microfluidic optical computing device during formation testing and sampling.

FIG. 7 illustrates a flow chart including steps in a method for measuring a characteristic of a sample with a microfluidic optical computing device.

In the figures, elements having the same or similar reference numerals have the same or similar function or description, unless otherwise indicated.

### DETAILED DESCRIPTION

The present disclosure relates to optical computing devices for material characterization and, more particularly, to optical computing devices including micro-photomultiplier tubes and microfluidics for use in the oil and gas industry.

Embodiments disclosed herein combine an integrated computational element (ICE) layer with micro-photomultiplier tubes (μPMTs) for multiplexing measurements in microfluidic chips with a low impact in the form factor of the resulting optical computing device. Embodiments consistent with the present disclosure position an ICE layer adjacent to a microfluidic layer illuminated by a light source in a light source layer. Accordingly, the ICE layer may be placed between the light source layer and the microfluidic layer, or between the microfluidic layer and a detector. The small form factor of the ICE layer, the microfluidic layer, and a μPMT enables devices as disclosed herein to be deployed in wireline or in measurement-while-drilling (MWD) tools close to the probe or drill bit and to measure characteristics of reservoir fluids before reacting with the probe or drill bit and result in inaccurate determinations or undesirable contamination. Other applications of embodiments as disclosed herein include the measurement of hydrocarbon fluid “color”, drilling mud additive determinations by fluorescence, or bacterial kill ratio by fluorescence.

As used herein, the term “characteristic” refers to a chemical, mechanical, or physical property of a substance. A characteristic of a substance may include a quantitative or qualitative value of one or more chemical constituents or compounds present therein or any physical property associated therewith. Such chemical constituents and compounds may be referred to herein as “analytes.” Illustrative characteristics of a substance that can be monitored with the optical computing devices described herein can include, for example, chemical composition (e.g., identity and concentration in total or of individual components), phase presence (e.g., gas, oil, water, etc.), impurity content, pH, alkalinity, viscosity, density, ionic strength, total dissolved solids, salt content (e.g., salinity), porosity, opacity, bacteria content, total hardness, combinations thereof, state of matter (solid, liquid, gas, emulsion, mixtures, etc.) and the like.

As used herein, the term “electromagnetic radiation” refers to radio waves, microwave radiation, infrared and near-infrared radiation, visible light, ultraviolet light, X-ray radiation and gamma ray radiation. Moreover as used herein, the term “electromagnetic radiation” is equivalent to the terms “light” and any of its uses in derivative phrases such as “illumination light,” “interacted light,” “sample interacted light,” “modified light,” “illumination light beam/” and the like.

As used herein, the term “optical computing device” refers to an optical device that is configured to receive an input of electromagnetic radiation associated with a substance and produce an output of electromagnetic radiation from a processing element arranged within the optical computing device. The processing element may be, for example, an integrated computational element (ICE), also known as a multivariate optical element (MOE). The electromagnetic radiation that optically interacts with the processing element is changed so as to be readable by a detector, such that an output of the detector can be correlated to a particular characteristic of the substance. The output of electromagnetic radiation from the processing, element can be reflected, transmitted, and/or dispersed electromagnetic radiation. Whether the detector analyzes reflected, transmitted, or dispersed electromagnetic radiation may be dictated by the structural parameters of the optical computing device as well as other considerations known to those skilled in the art. In addition, emission and/or scattering of the fluid, for exam pie via fluorescence, luminescence, Raman, Mie, and/or Raleigh scattering, can also be monitored by optical computing devices.

As used herein, the term “optically interact.” or variations thereof refers to the reflection, transmission, scattering, diffraction, or absorption of electromagnetic radiation either on, through or from one or more processing elements (i.e., ICE or MOE components) or a substance being analyzed by the processing elements. Accordingly, optically interacted light refers to electromagnetic radiation that has been reflected, transmitted, scattered, diffracted, or absorbed by, emitted, or re-radiated, for example, using a processing element, but may also apply to interaction with a substance.

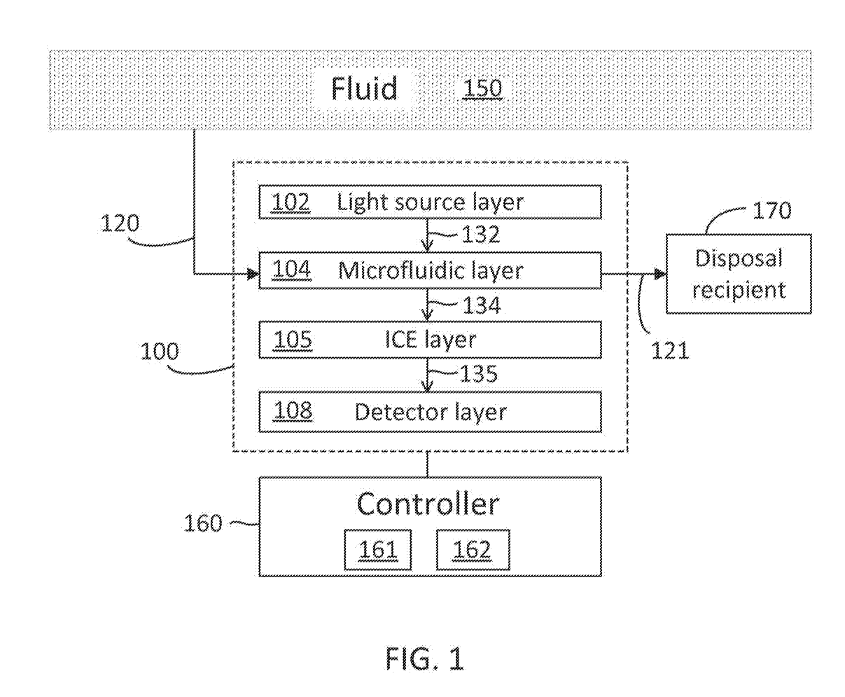

FIG. 1 illustrates a block diagram of a system for measuring a characteristic of a sample 150 using a microfluidic optical computing device 100. The sample 150 may comprise a fluid, such as a liquid found in a borehole operation in the oil and gas industry. A controller 160 is communicably coupled to microfluidic optical computing device 100. Controller 160 may include a processor 161 and a memory 162 storing instructions that, when executed by processor 161, cause controller 160 to control and receive data from microfluidic optical computing device 100, according to methods disclosed herein. Microfluidic optical computing device 100 is fluidically coupled with sample 150 through an inlet conduit 120 that may receive a portion of fluid sample 150 and convey the portion to microfluidic optical computing device 100. Following processing in the microfluidic optical computing device 100, an exhaust fluid is provided to a disposal recipient 170 through an outlet conduit 121. In some embodiments disposal recipient 170 is the same fluid channel or reservoir from which sample 150 was retrieved. Microfluidic optical computing device includes a plurality of layers, namely a light source layer 102, a microfluidic layer 104, an ICE layer 105m and a detector layer 108. As defined herein, the term “layer” referred to any one of the above mentioned elements is synonymous with a structural component having one or more elements, wherein the structural component is coupled in series with other structural components to make up a device, such as microfluidic optical computing device 100.

In some embodiments, microfluidic optical computing device 100 includes a light source layer 102 having at least one light source generating an illumination light 132. Illumination light 132 interacts with a portion of sample 150 in a microfluidic layer 104 to generate a sample interacted light 134. In some embodiments, microfluidic layer 104 includes a microfluidic channel that receives a portion of sample 150. The microfluidic channel may be formed in a transparent substrate so that illumination light 132 passes through the microfluidic channel. In some embodiments, microfluidic optical computing device 100 includes an integrated computational element (ICE) layer 105 including an ICE core to generate a modified light 135 from sample interacted light 134. Microfluidic optical computing device 100 may include a detector 108 configured to measure an intensity of modified light 135 and to generate an output signal corresponding to a characteristic of the sample.

While FIG. 1 illustrates ICE layer 105 placed between microfluidic layer 104 and detector 108, this configuration is not limiting of other embodiments consistent with the present disclosure. For example, in some embodiments ICE layer 105 may be placed between light source layer 102 and microfluidic layer 104. In fact, in some embodiments ICE layer 105 may be integrated into or with light source layer 102, or into or with microfluidic layer 104, without departing from the scope of the disclosure.

In some embodiments, interacted light 134 comprises at least one of a Raman shifted light, a fluorescence emission light, a refracted light under a modified index of refraction, and a selectively absorbed light. The selectively absorbed light may result from a spectral absorption change in the interacted light as it goes through the portion of the sample in the microfluidic channel, wherein the portion of the sample contains an amount of the selected characteristic.

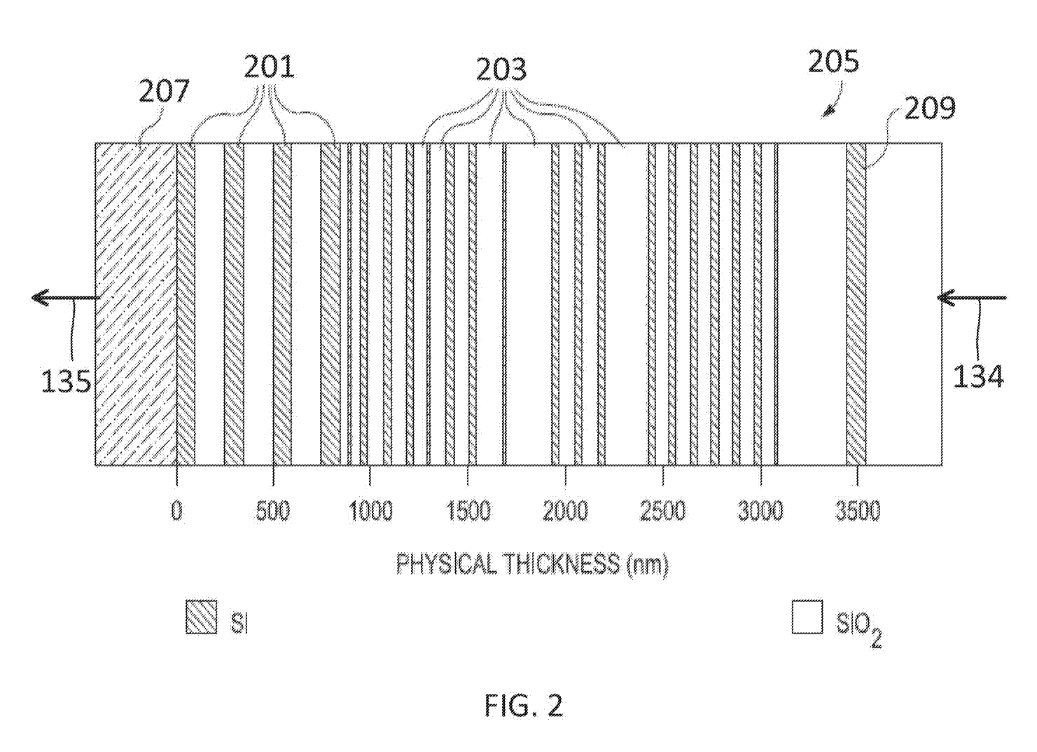

FIG. 2 illustrates a cross-sectional view of ICE core 205 including sample interacted light 134 and modified light 135 in a microfluidic optical computing device as disclosed herein (e.g., microfluidic optical computing device 100, cf. FIG. 1). In some embodiments, ICE core 205 may be included in ICE layer 105 (cf. FIG. 1). FIG. 2 illustrates modified light 135 travelling in the same direction as sample interacted light 134 and leaving ICE core 205 on the opposite side of sample interacted light 134, in a transmissive configuration. In some embodiments, modified light 135 may travel in the opposite direction to sample interacted light 134, in a reflective configuration. Moreover, in some embodiments ICE core 205 may be designed such that sample interacted light 134 impinges upon ICE core 205 at a predetermined angle different from 0° (zero degrees) and modified light 135 reflects off ICE core 205 at the predetermined angle. ICE core 205 processes sample interacted light 134 to produce modified light 135. Modified light 135 is directed to detector 108 (cf. FIG. 1) which produces an output signal proportional to the characteristic amount of analyte present in the sample based on the intensity of modified light 135.

As illustrated, ICE core 205 may include a plurality of alternating layers 201 and 203, such as silicon (Si) and SiO₂ (quartz), respectively. In general, layers 201 and 203 include materials whose index of refraction is high and low, respectively. Other examples of materials for use in layers 201 and 203 might include niobia and niobium, germanium and germania, MgF, SiO, and other high and low index materials known in the art. Layers 201 and 203 may be strategically deposited on an optical substrate 207. In some embodiments, optical substrate 207 is BK-7 optical glass. In other embodiments, optical substrate 207 may be another type of optical substrate, such as quartz, sapphire, silicon, germanium, zinc selenide, zinc sulfide, or various plastics such as polycarbonate, polymethylmethacrylate (PMMA), polyvinylchloride (PVC), diamond, ceramics, combinations thereof, and the like.

At the opposite end (e.g., opposite the optical substrate 207 in FIG. 2), ICE core 205 may include a layer 209 that is generally exposed to the environment of the device or installation, and may be able to detect a sample substance. The number of layers 201 and 203 and the thickness of each of the plurality of layers 201, and 203 are determined from the spectral attributes acquired from a spectroscopic analysis of a characteristic of the sample being analyzed using a conventional spectroscopic instrument. The spectrum of interest of a given characteristic typically includes any number of different wavelengths. It should be understood that the exemplary ICE core 205 in FIG. 2 does not in fact represent any particular characteristic of a given substance or sample, but is provided for purposes of illustration only. Consequently, the number of layers 201 and 203 and their thicknesses, as shown in FIG. 2, bear no correlation to any particular characteristic. Nor are the layers 201 and 203 and their thicknesses necessarily drawn to scale, and therefore should not be considered limiting of the present disclosure. Moreover, those skilled in the art will readily recognize that the materials that make up each of the plurality of layers 201 and 203 (i.e., Si and SiO₂) may vary, depending on the application, cost of materials, and/or applicability of the material to the given substance being analyzed.

In some embodiments, the material of each layer 201 and 203 can be doped, or two or more materials can be combined in a manner to achieve the desired optical characteristic. In addition to solids, ICE core 205 may also contain liquids and/or gases, optionally in combination with solids, in order to produce a desired optical characteristic. In the case of gases and liquids, ICE core 205 can contain a corresponding vessel (not shown), which houses the gases or liquids. Exemplary variations of ICE core 205 may also include holographic optical elements, gratings, piezoelectric, light pipe, and/or acousto-optic elements, for example, that can create transmission, reflection, and/or absorptive properties of interest.

Layers 201 and 203 exhibit different refractive indices. By properly selecting the materials of the layers 201 and 203 and their relative thickness and spacing, ICE core 205 may be configured to selectively pass/reflect/refract predetermined fractions of electromagnetic radiation at different wavelengths. Each wavelength is given a predetermined weighting or loading factor. The thickness and spacing of layers 201 and 203 may be determined using a variety of approximation methods from the spectrum of the characteristic or analyte of interest. These methods may include inverse Fourier transform (IFT) of the optical transmission spectrum and structuring ICE core 205 as the physical representation of the IFT. The approximations convert the IFT into a structure based on known materials with constant refractive indices.

The weightings that layers 201 and 203 of ICE core 205 apply at each wavelength are set to the regression weightings described with respect to a known equation, or data, or spectral signature. When electromagnetic radiation interacts with a substance, unique physical and chemical information about the substance may be encoded in the electromagnetic radiation that is reflected from, transmitted through, or radiated from the substance. This information is often referred to as the spectral “fingerprint” of the substance. ICE core 205 performs the dot product of the electromagnetic radiation received by ICE core 205 and the wavelength dependent transmission function of ICE core 205. The wavelength dependent transmission function of the ICE core 205 is dependent on the layer material refractive index, the number of layers 201 and 203 and the layer thicknesses. The transmission function of ICE core 205 is designed to mimic a desired regression vector derived from the solution to a linear multivariate problem targeting a specific component of the sample being analyzed. As a result, the intensity of modified light 135 is proportional to a dot product of a transmission spectrum of the sample with the regression vector associated with the characteristic of interest. Accordingly, the output light intensity of ICE core 205 is a direct indicator of a value of the characteristic of interest of a sample.

In some embodiments, the choice of the number and thicknesses of layers 201 and 203 is not unique for a given characteristic of interest of a sample. Accordingly, in some embodiments more than one ICE core 205 may be used to obtain modified light 135 for a single characteristic of a sample. For example, in some embodiments two, three, four or even more different sets of alternating layers 201 and 203 may be obtained to target the same characteristic of the sample. Other combination of ICE cores 205 may be found useful to increase sensitivity and accuracy in the determination of a characteristic of a sample. In some embodiments, a second ICE core 205 may be designed to be disassociated with the characteristic of the sample such that the intensity of modified light 135 is indifferent to the value of the characteristic of the sample. Accordingly, some embodiments may combine an ICE core 205 associated with the characteristic of the sample with a second ICE core 205 disassociated with the characteristic of the sample in order to obtain a more accurate or a more sensitive measurement of the characteristic of the sample. Embodiments of microfluidic optical computing device 100 (FIG. 1) as disclosed herein are well suited to apply different combinations of ICE cores as described above by the ability to include a plurality of microfluidic channels separated in space, each carrying substantially the same or similar sample content. Accordingly, multiple ICE cores 205 may be assigned to the microfluidic channels in the microfluidic layer. In some embodiments, multiple ICE cores 205 may be assigned to a single microfluidic channel.

Microfluidic optical computing device 100 (FIG. 1) employing ICE core 205 may be capable of extracting the information of the spectral fingerprint of multiple characteristics or analytes within a substance and converting that information into a detectable output regarding the overall properties of the substance. That is, through suitable configurations of optical computing devices, electromagnetic radiation associated with characteristics or analytes of interest in a substance can be separated from electromagnetic radiation associated with all other components of the substance in order to estimate the properties of the substance in real-time or near real-time. Accordingly, ICE core 205 is able to distinguish and process electromagnetic radiation related to a characteristic or analyte of interest.

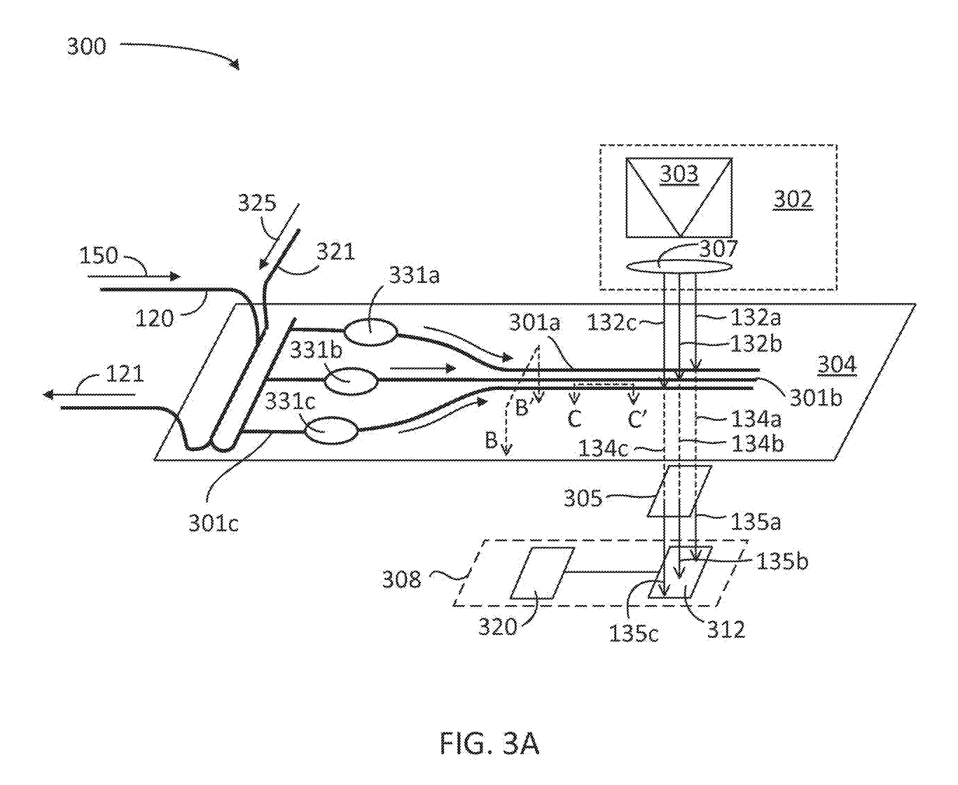

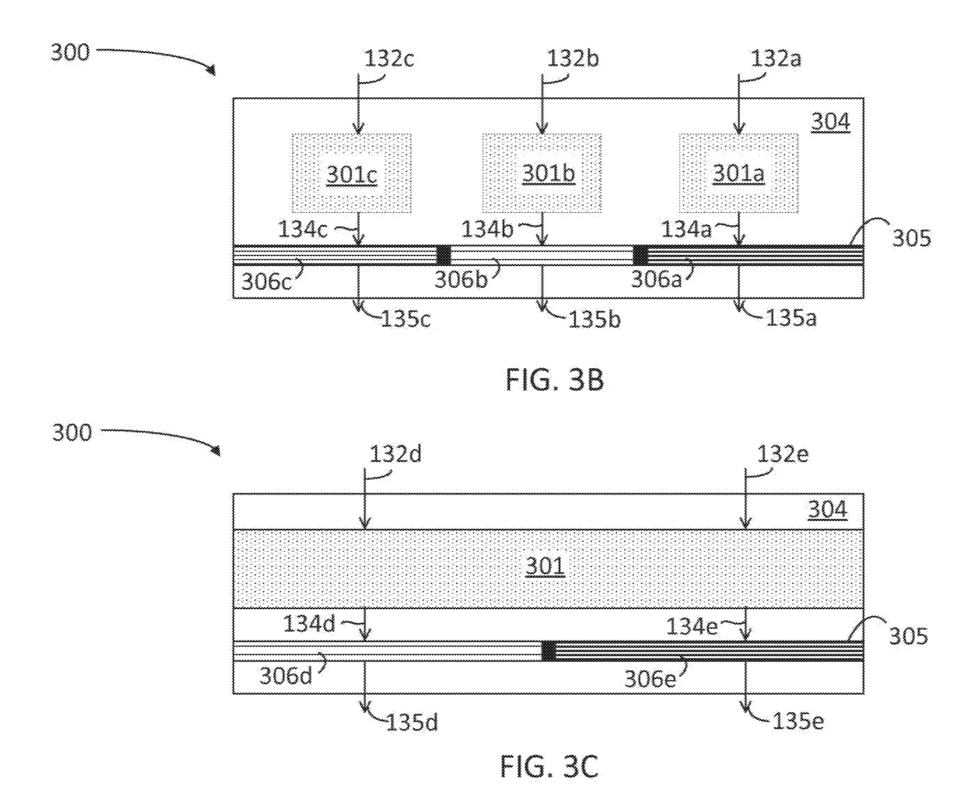

FIG. 3A illustrates an exemplary microfluidic optical computing device 300 that includes a light source layer 302, a microfluidic layer 304, an ICE layer 305 and a detector layer 308. Light source layer 302 may include a light source 303 and an optical element 307. Light source 303 may be a laser, a light emitting diode (LED), or a plurality of lasers and LEDs formed into a linear or a two-dimensional array, or a broadband source. The optical element 307 may direct each one of illuminating light beams 132a, 132b and 132c (hereinafter collectively referred to as illuminating lights 132) to corresponding microfluidic channels 301a, 301b, and 301c (hereinafter collectively referred to as microfluidic channels 301), respectively. In some embodiments, optical element 307 may comprise a diffractive optical element, or a micro-lens array. In some embodiments, each of illuminating light beams 132 has a selected or predetermined wavelength. Further, in some embodiments, light source 303 is a pulsed light source and each of light beams 132 is pulsed at a selected or predetermined time interval.

Microfluidic layer 304 includes a plurality of microfluidic channels 301 that receive illuminating light beams 132 provided by light source layer 302. Illuminating light beams 132 generate sample interacted light beams 134a, 134b, and 134c (hereinafter collectively referred to as sample interacted light beams 134) as they traverse microfluidic layer 304. Sample interacted light beams 134 interact with ICE layer 305 and thereby form modified light beams 135a, 135b, and 135c (hereinafter collectively referred to as modified light beams 135).

Sample fluid 150 is introduced from input channel 120 into at least one of microfluidic channels 301 in microfluidic layer 304 either passively (i.e. through capillary action) or by a positive displacement force (i.e. electro-osmotic flow). In some embodiments, sample fluid 150 interacts with a solvent 325 in channel 321 to provide a change to sample fluid 150 depending on the amount of analyte present in the sample. Solvent 325 may push sample fluid 150 through microfluidic channels 301, and also act as a cleaning mechanism in order to prepare microfluidic layer 304 for a fresh measurement. In some embodiments, instead or solvent 325, channel 321 may transport extra amounts of fluid sample 150 from a different location. The change induced in sample fluid 150 by solvent 325 may be a color change or a change in some other optical property, such as a spectroscopic property.

Sample fluid 150 is further exposed in microfluidic layer 304 to any one of indicators 331a, 331b, or 331c (hereinafter collectively referred to as indicators 331). In some embodiments, indicators 331 may include reagents that induce an optical change to sample fluid 150 proportional to the value of the characteristic of the sample. In some embodiments, the optical change induced by indicators 331 in sample fluid 150 may be proportional to, or commensurate with, the value of the characteristic of interest in the sample. The optical change can be induced by a chemical reaction between indicators 331 and a substance associated with the characteristic or interest in the sample (e.g., a gas such as CO₂, CH₄, or a hydrocarbon such as C₁-C₅, saturates, aromatics, resins, and asphaltenes -SARA-, or H₂S). Accordingly, the chemical reaction may result in a change in the index of refraction of microfluidic channels 301, a change in a fluorescence lifetime or a fluorescence wavelength in microfluidic channels 301, or appearance or a change in the Raman shift in at least one of microfluidic channels 301.

Modified light beams 135 impinge on a photosensitive portion 312 of defector layer 308. Upon receipt of modified light beams 135, photosensitive portion 312 induces a signal in driver circuit 320, which thereafter transmits the signal to controller 160 (ct. FIG. 1). To reduce the form factor of microfluidic optical computing device 300, some embodiments use a single photosensitive portion 312 receiving the plurality of modified light beams 135. In some embodiments, microfluidic layer 304 augments the concentration of an analyte, including the characteristic or interest, in the sample in one of microfluidic channels 301. For example, a hydrophobic or a hydrophilic membrane separating two of microfluidic channels 301 may create a concentration differential of a selected analyte between the two microfluidic channels 301. Some embodiments use this strategy to enhance the signal-to-noise ratio (SNR) of microfluidic optical computing device 300. Furthermore, to enhance SNR, some embodiments collect a signal from a sum of the plurality of modified light beams 135 with device circuit 320 in detector layer 308.

FIG. 3B is a cross-sectional view of microfluidic optical computing device 300 of FIG. 3A as taken along lines B-B′. More particularly, FIG. 3B illustrates a microfluidic layer 304 and an ICE layer 305 in microfluidic optical computing device 300. In some embodiments, ICE layer 305 may include a plurality of ICE cores 306a, 306b, and 306c (hereinafter referred to collectively as ICE cores 306) to generate modified lights 135a, 135b, and 135c, respectively, from microfluidic channels 301. Accordingly, each of ICE cores 306 may be associated with a specific characteristic of the sample in liquid 150. More generally, each of ICE cores 306 may be associated with a pre-determined interacted light, for example, ICE core 306a may be associated with a Raman shift, ICE core 306b may be associated with a fluorescence emission, and ICE core 306c may be associated with an absorption signal (e.g., a near-infrared—NIR-absorption signal).

FIG. 3C is a cross-sectional view of microfluidic optical computing device 300 of FIG. 3A as taken along lines C-C′. More particularly, FIG. 3C illustrates a microfluidic layer 304 and ah ICE layer 305 in microfluidic optical computing device 300. In some embodiments, ICE layer 305 may include a plurality of ICE cores 306d and 306e (hereinafter identified as ICE cores 306, as above) to generate modified lights 135 from microfluidic channels 301. ICE cores 306d and 306e may be configured to form a reference signal or a complementary signal from either one of ICE cores 306, to enhance the SNR of the value for the characteristic of interest in the sample. For example, ICE core 306d may be associated with a first characteristic of the sample, and ICE core 306e may be disassociated with the first characteristic of the sample. In some embodiments ICE core 306d is different from ICE core 306e and both may be associated with the same characteristic of the sample. Moreover, in some embodiments, ICE core 306d is associated with a second characteristic of the sample that is different from the first characteristic of the sample. Similar configurations may be envisioned that increase the sensitivity, the accuracy, or both the sensitivity and the accuracy of a measurement, according to embodiments consistent with the present disclosure.

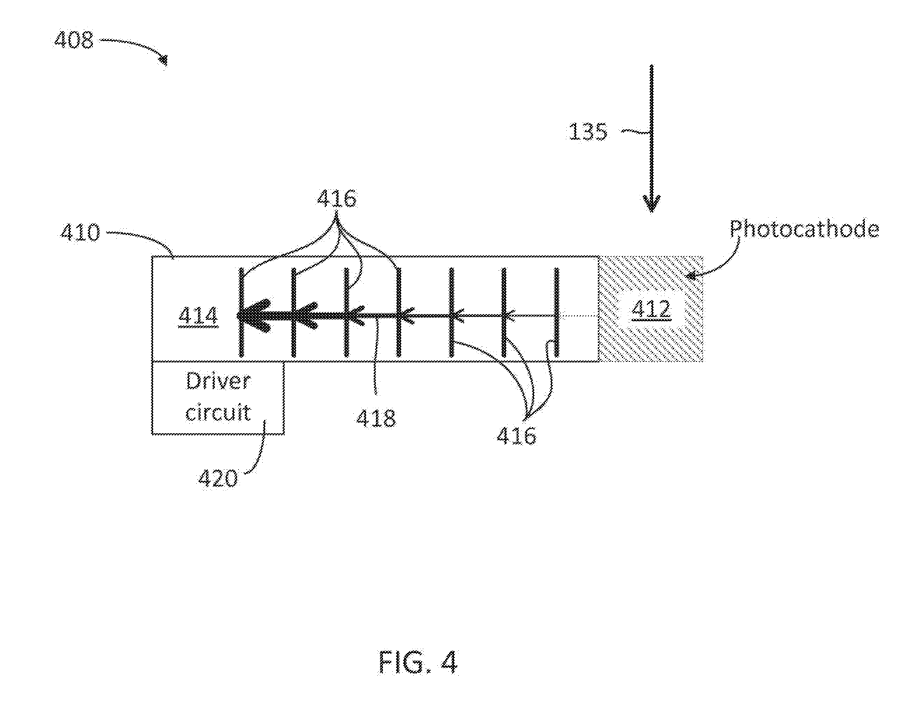

FIG. 4 illustrates a detector 408 in a microfluidic optical computing device. In some embodiments, detector 408 may include a μPMT 410 that receives modified light 135 at a photocathode 412. Although PMTs have been in use for many years, their size has prevented them for use in smaller forms desirable for extreme environments such as oil and gas borehole applications. The manufacturing process of traditional PMTs involved manual labor during most parts of the process. PMTs as disclosed herein, however, have small form factors and are, therefore, easier to mass-produce. Smaller PMTs, as disclosed herein (e.g., μPMTs), can be used to collect modified light 135 with a desirable SNR. μPMT 410 maintains the key features of a PMT such as high sensitivity, low noise, high speed, and low temperature dependence, but also has unconventional features such as small size, decreased weight, rugged structure, and easy mass production.

When modified light 135 impinges on photocathode 412, the light signal is changed into photoelectrons, which are then emitted into vacuum chamber 414. Photocathode 412 may include a metal having a work function suitable for the expected wavelength of modified light 135. In vacuum chamber 414, an electron cascade 418 is created by a series of dynodes 416, each of which is a metal set at a higher voltage potential than the previous one. Driver circuit 420 collects electron cascade 418 at the anode (last dynode in the series of dynodes 416).

The operating principle of μPMT 410 is similar to conventional PMTs and provides ultrafast response and extremely high sensitivity sufficient to measure single photons. In some embodiments, μPMT 410 is supplied with about 900 V between photocathode 412 and the anode in dynode chain 416 to create a strong electric field, resulting in a final gain of 10⁶, 2×10⁶, or even more. That is, out of a single photoelectron emitted in photocathode 412, one (1) million or two (2) million electrons may be received by driver circuit 420, producing an output signal. The spectral response for μPMT 410 depends on the photosensitivity of photocathode 412, which is typically made of a metal. In some embodiments, photocathode 412 is responsive in a wavelength range from approximately 350 nm to approximately 650 nm, or the visible spectral region. In some embodiments, photocathode 412 is responsive at longer wavelengths up to 1000 nm or even 1100 nm. In yet some embodiments, photocathode 412 may be responsive at wavelengths up to 1500 nm or 1600 nm.

In some embodiments, the design of μPMT 410 involves electron trajectory simulation, micro-electromechanical systems (MEMS), and vacuum-tube design technologies. μPMT 410 is compact and has the same operating principle as conventional PMTs. In some embodiments, μPMT 410 may have a form factor of approximately 13(length)×10(width)×2(height) mm, and a weight of about 0.6 g. The cubic volume may be about 1/7 and the weight 1/9 of a small conventional PMT. In addition, design of μPMT 410 can be customized because the vacuum chamber 414 and dynode structure 416 may be fabricated on a silicon wafer. Making a customized μPMT only requires creating a photo-mask with a simple structure. Technically, it is possible to fabricate μPMTs of different shapes on one wafer.

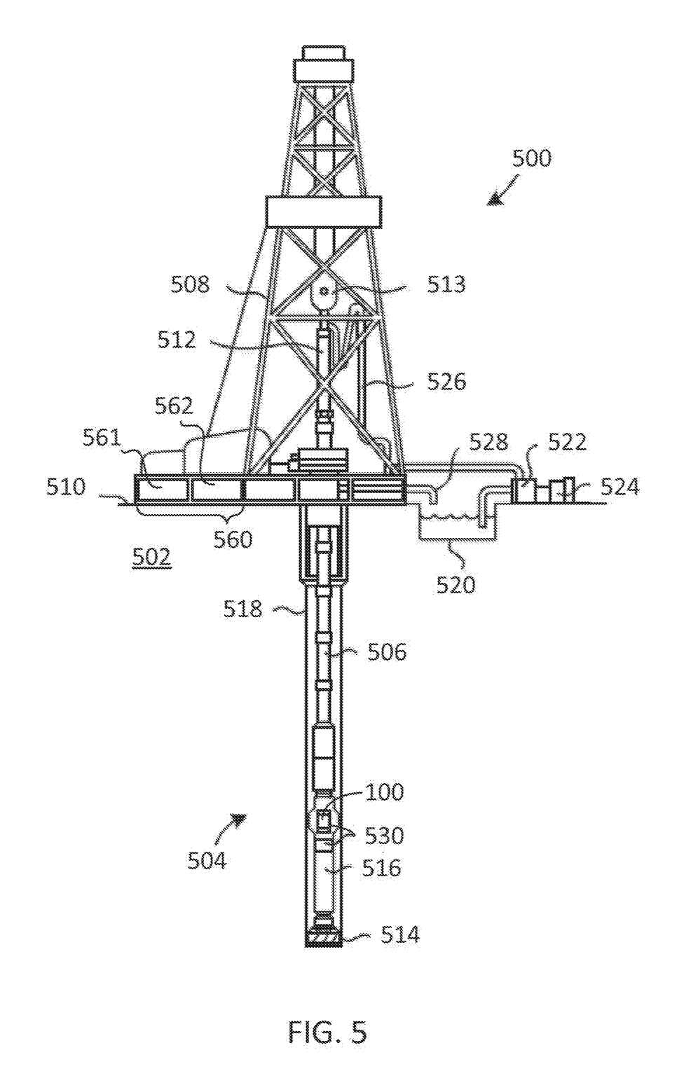

FIG. 5 illustrates a drilling system 500 configured to use an optical sensor including a microfluidic optical computing device in a measurement-while-drilling (MWD) and a logging-while-drilling (LWD) operation. Boreholes may be created by drilling into the earth 502 using drilling system 500. Drilling system 500 may be configured to drive a bottom hole assembly (BHA) 504 positioned or otherwise arranged at the bottom of a drill string 506 extended into the earth 502 from a derrick 508 arranged at the surface 510. The derrick 508 includes a kelly 512 and a traveling block 513 used to lower and raise the kelly 512 and the drill string 506.

The BHA 504 may include a drill tool 514 operatively coupled to a tool string 516 which may be moved axially within a drilled well bore 518 as attached to the tool string 516. During operation, drill tool 514 penetrates the earth 502 and thereby creates wellbore 518. BHA 504 provides directional control of drill tool 514 as it advances into earth 502. Tool string 516 can be semi-permanently mounted with various measurement tools (not shown) such as, but not limited to, measurement-while-drilling (MWD) and logging-while-drilling (LWD) tools, that may be configured to take downhole measurements of drilling conditions. In other embodiments, the measurement tools may be self-contained within drill string 506, as shown in FIG. 5.

Fluid or “drilling mud” from a mud tank 520 may be pumped downhole using a mud pump 522 powered by an adjacent power source, such as a prime mover or motor 524. The drilling mud may be pumped from mud tank 520, through a stand pipe 526, which feeds the drilling mud into drill string 506 and conveys the same to drill tool 514. The drilling mud exits one or more nozzles arranged in drill tool 514 and in the process cools drill tool 514. After exiting drill tool 514, the mud circulates back to the surface 510 via the annulus defined between the wellbore 518 and the drill string 506, and in the process returns drill cuttings and debris to the surface. The cuttings and mud mixture are passed through a flow line 528 and are processed such that a cleaned mud is returned down hole through the stand pipe 526 once again.

BHA 504 may further include a downhole tool 530. Downhole tool 530 may include a sensor that incorporates the use of a microfluidic optical computing device 100. Downhole tool 530 may be positioned between drill string 506 and drill tool 514.

A controller 560 including a processor 561 and a memory 562 is communicatively coupled to microfluidic optical computing device 100 in downhole tool 530. While microfluidic optical computing device 100 may be placed at the bottom of wellbore 518, and extend for a few inches, a communication channel may be established by using electrical signals or mud pulse telemetry for most of the length of tool string 506 from drill tool 514 to controller 560. Memory 562 includes commands which, when executed by processor 561 cause controller 560 to perform steps in methods consistent with the present disclosure. More specifically, controller 560 may provide commands to and receive data from microfluidic optical computing device 100 during operation. For example, in some embodiments, controller 560 may receive information from microfluidic optical computing device 100 about drilling conditions in wellbore 518 and controller 560 may provide a command to BHA 504 to modify certain drilling parameters. For example, controller 560 may provide a command to adjust or change the drilling direction of drill tool 514 based on a message contained in information provided by microfluidic optical computing device 100. In that regard, the information provided by microfluidic optical computing device 100 to controller 560 may include certain drilling conditions such as physical or chemical properties of the drilling mud in the subterranean environment. More generally, microfluidic optical computing device 100 may provide data such as gas-oil-ratio (GOR) content, a methane concentration, a CO₂ concentration, or a hydrocarbon content of a fluid in the borehole. Accordingly, controller 560 may use processor 561 to determine a characteristic of the sample in a medium surrounding drill tool 562 using the data collected from microfluidic optical computing device 100.

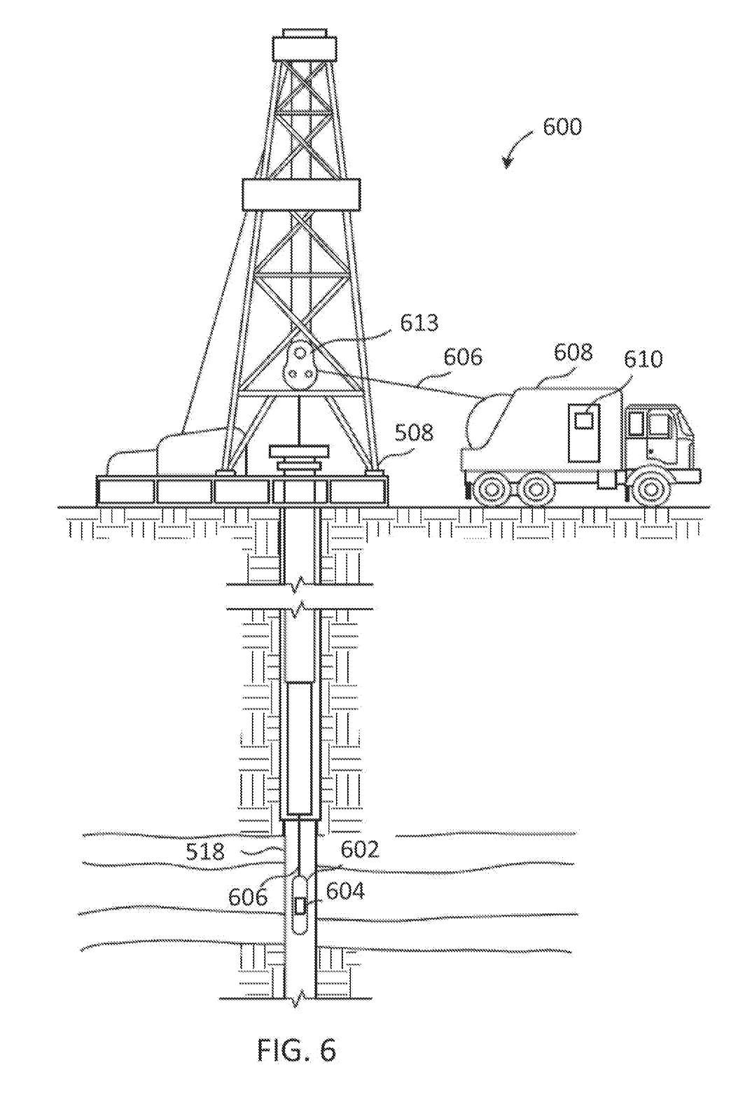

FIG. 6 illustrates a wireline system 600 configured to use an optical sensor including a microfluidic optical computing device 604 during formation testing and sampling. After drilling of wellbore 518 is complete, it may be desirable to know more details of types of formation fluids and the associated characteristics through sampling with use of wireline formation tester. System 600 may include a wireline logging tool 602 that forms part of a wireline logging operation that can include one or more microfluidic optical computing devices 604 as described herein (e.g., microfluidic optical computing devices 100 and 300, cf. FIGS. 1 and 3, respectively). System 600 may include derrick 508 supporting the traveling block 613. Wireline logging tool 602, such as a probe or sonde, may be lowered by wireline or logging cable 606 into borehole 518. Tool 602 may be lowered to the bottom of the region of interest and subsequently pulled upward at a substantially constant speed by wireline or logging cable 606. Tool 602 may be configured to measure fluid properties of the wellbore fluids, and any measurement data generated by wireline logging tool 602 and its associated optical computing devices 604 can be communicated to a surface logging facility 608 for storage, processing, and/or analysis. Any one of microfluidic optical computing devices 604 may include an ICE layer according to embodiments disclosed herein (e.g., ICE layers 105 and 305, cf. FIG. 1 and FIGS. 3A-3C). Logging facility 608 may be provided with electronic equipment 610, including processors for various types of signal processing.

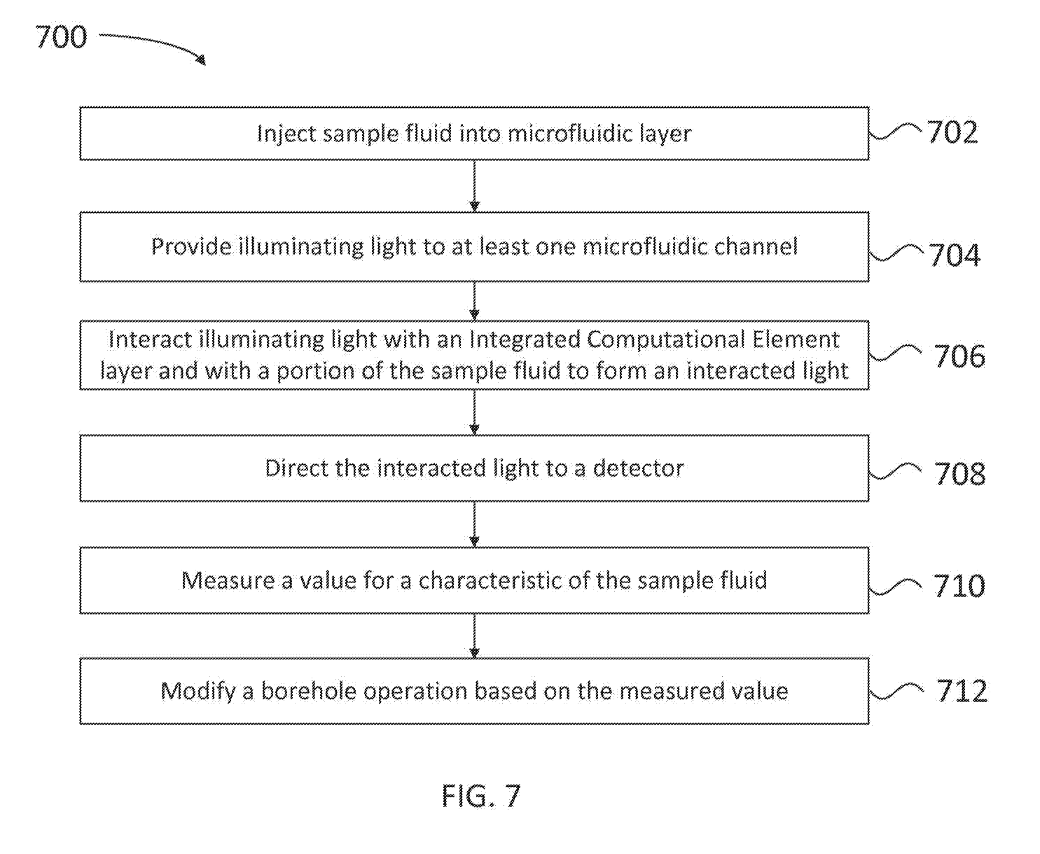

FIG. 7 illustrates a flow chart including steps in a method 700 for measuring a characteristic of a sample. In some embodiments, steps in method 700 may be performed at least partially by a controller including a processor and a memory (e.g., controllers 160 and 560, processors 161 and 561, and memories 162 and 562, cf. FIGS. 1 and 5). The memory may store commands that, when executed by the processor, cause the controller to perform at least some of the steps in method 700. Accordingly, methods consistent with method 700 may be performed in connection with a microfluidic optical computing device including a light source layer, a microfluidic layer, an ICE layer, and a detector layer (e.g., microfluidic optical computation device 100, light source layer 102, microfluidic layer 104, ICE layer 105, and detector layer 108, cf. FIG. 1). The sample may be a fluid in a borehole operation for the oil and gas industry.

Methods consistent with method 700 may include fewer steps than illustrated in FIG. 7 or other steps in addition to at least one of the steps in method 700. Moreover, methods consistent with the present disclosure may include at least one or more of the steps in method 700 performed in a different sequence. For example, some embodiments consistent with the present disclosure may include at least two steps in method 700 performed overlapping in time, or substantially simultaneously in time.

Step 702 includes injecting a sample fluid into a microfluidic layer. In some embodiments, step 702 includes injecting a drilling mud into the at least one microfluidic channel, and the characteristic of the sample fluid is the content of an additive in the drilling mud. In yet other embodiments, step 702 includes injecting at least one of a solvent or a reagent into the microfluidic layer. In some embodiments, step 702 includes injecting the sample fluid into at least two microfluidic channels, providing a first illuminating light to a first one of the at least two microfluidic channels, and providing a second illuminating light to a second one of the at least two microfluidic channels.

Step 704 includes providing an illuminating light to at least one microfluidic channel in the microfluidic layer. Step 700 includes interacting the illuminating light with an integrated computational element (ICE) layer and with a portion of the sample fluid to form an interacted light. Step 708 includes directing the interacted light to a detector. Step 710 includes measuring a value for a characteristic of the sample with a detector signal. In some embodiments, step 710 includes measuring one of a color of the sample fluid, a C₁-C₅ content in the sample fluid, a SARA content in the sample fluid, a CO₂ content in the sample fluid, or an H₂S content in the sample fluid. In yet other embodiments, step 710 includes measuring a bacterial kill ratio in a production fluid of a borehole operation.

Step 712 includes modifying a borehole operation based on the measured value. In some embodiments, step 712 includes at least one of modifying an additive composition in a drill mud, modifying a drilling direction of a drill bit, or modifying a pump flow rate of the drill mud into the borehole.

Those skilled in the art will readily appreciate that the methods described herein, or large portions thereof may be automated at some point such that a computerized system may be programmed to use a system incorporating a micro-photomultiplier and microfluidics with an ICE layer. Computer hardware used to implement the various methods and algorithms described herein can include a processor configured to execute one or more sequences of instructions, programming stances, or code stored on a non-transitory, computer-readable medium. The processor can be, for example, a general purpose microprocessor, a microcontroller, a digital signal processor, an application specific integrated circuit, a field programmable gate array, a programmable logic device, a controller, a state machine, a gated logic, discrete hardware components, an artificial neural network, or any like suitable entity that can perform calculations or other manipulations of data. In some embodiments, computer hardware can further include elements such as, for example, a memory (e.g., random access memory (RAM), flash memory, read only memory (ROM), programmable read only memory (PROM), electrically erasable programmable read only memory (EEFROM)), registers, hard disks, removable disks, CD-ROMS, DVDs, or any other like suitable storage device or medium.

Executable sequences described herein can be implemented with one or more sequences of code contained in a memory. In some embodiments, such code can be read into the memory from another machine-readable medium. Execution of the sequences of instructions contained in the memory can cause a processor to perform the process steps described herein. One or more processors in a multi-processing arrangement can also be employed to execute instruction sequences in the memory. In addition, hard-wired circuitry can be used in place of or in combination with software instructions to implement various embodiments described herein. Thus, the present embodiments are not limited to any specific combination of hardware and/or software.

As used herein, a machine-readable medium will refer to any medium that directly or indirectly provides instructions to a processor for execution. A machine-readable medium can take on many forms including, for example, non-volatile media, volatile media, and transmission media. Non-volatile media can include, for example, optical and magnetic disks. Volatile media can include, for example, dynamic memory. Transmission media can include, for example, coaxial cables, wire, fiber optics, and wires that form a bus. Common forms of machine-readable media can include, for example, floppy disks, flexible disks, hard disks, magnetic tapes, other like magnetic media, CD-ROMs, DVDs, other like optical media, punch cards, paper tapes and like physical media with patterned holes, RAM, ROM, PROM, EPROM and flash EPROM.

Embodiments disclosed herein include:

A. A microfluidic optical computing device including a microfluidic layer inducing a microfluidic channel that receives a sample, at least one light source generating an illumination light to interact with the sample in the microfluidic channel to generate a sample interacted light, an integrated computational element (ICE) layer including an ICE core to generate a modified light from the sample interacted light, and a detector layer configured to measure an intensify of the modified light and to generate an output signal corresponding to a characteristic of the sample.

B. A method of measuring a characteristic of a sample fluid, including: injecting the sample fluid into a microfluidic layer, providing an illuminating light to at least one microfluidic channel in the microfluidic layer, interacting the illuminating light with an integrated computational element (ICE) arranged in an ICE layer and with the sample fluid to form interacted light, directing the interacted light to a detector, and determining a value for a characteristic of the sample fluid based on a detector signal generated by the detector.

Each of embodiments A and B may have one or more of the following additional elements in any combination: Element 1: wherein the detector layer includes a photomultiplier detector. Element 2: wherein the ICE layer is disposed between the light source and the microfluidic layer. Element 3: wherein the interacted light includes at least one of a Raman shifted light, a fluorescence emission light, a refracted light, and a selectively absorbed light. Element 4: wherein the sample is exposed in the microfluidic layer to an indicator that induces an optical change to the sample that is proportional to the characteristic of the sample. Element 5: wherein the microfluidic layer augments a concentration of an analyte including the characteristic of the sample in the at least one microfluidic channel. Element 6: wherein the microfluidic layer includes a plurality of microfluidic channels and the at least one light source generates a plurality of illuminating light beams, the device further comprising an optical element that directs each one of the plurality of illuminating light beams to at least one microfluidic channel from the plurality of microfluidic channels and thereby generates a plurality of sample interacted lights. Element 7: wherein the ICE layer further includes a second ICE core to generate a second modified light from a sample interacted light coming from a second microfluidic channel from the plurality of microfluidic channels. Element 8: wherein the at least one light source provides a plurality of illuminating light beams, each light beam having a selected wavelength. Element 9: wherein the at least one light source provides a plurality of illuminating light beams, each light beam being pulsed at a selected time interval. Element 10: wherein the detector collects a signal from a sum of the plurality of sample interacted lights.

Element 11: further including modifying a borehole operation based on the value determined for the characteristic of the sample fluid. Element 12: wherein injecting the sample fluid into the microfluidic layer includes injecting a drilling mud into the at least one microfluidic channel, the characteristic of the sample fluid being indicative of an additive suspended in the drilling mud. Element 13: wherein injecting the sample fluid into the microfluidic layer includes injecting at least one of a solvent or a reagent into the microfluidic layer. Element 14: wherein injecting the sample fluid into the microfluidic layer further includes: injecting the sample fluid into at least two microfluidic channels, providing a first illuminating light to a first one of the at least two microfluidic channels, and providing a second illuminating light to a second one of the at least two microfluidic channels. Element 15: wherein determining the value for the characteristic of the sample fluid includes measuring at least one of a color of the sample fluid, a C₁-C₅ content in the sample fluid, a saturates, aromatics, resins, and asphaltenes content in the sample fluid, a CO₂ content in the sample fluid, and an H₂S content in the sample fluid. Element 16: wherein determining the value for the characteristic of the sample fluid includes measuring a bacterial kill ratio in a production fluid of a borehole operation. Element 17: further including modifying a borehole operation based on the value for the characteristic of the sample fluid. Element 18: wherein modifying the borehole operation includes at least one of modifying an additive composition in a drilling fluid, modifying a drilling direction of a drill bit, or modifying a pump flow rate of the drilling fluid into the borehole.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range failing within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

1. A microfluidic optical computing device comprising:
a microfluidic layer including a microfluidic channel that receives a sample;
at least one light source generating an illumination light to interact with the sample in the microfluidic channel to generate a sample interacted light;
an integrated computational element (ICE) layer including an ICE core to generate a modified light from the sample interacted light; and
a detector layer configured to measure an intensity of the modified light and to generate an output signal corresponding to a characteristic of the sample.

2. The device of claim 1, wherein the detector layer includes a photomultiplier detector.

3. The device in claim 1, wherein the ICE layer is disposed between the light source and the microfluidic layer.

4. The device of claim 1, wherein the sample interacted light includes at least one of a Raman shifted light, a fluorescence emission light, a refracted light, and a selectively absorbed light.

5. The device of claim 1, wherein the sample is exposed in the microfluidic layer to an indicator that induces an optical change to the sample that is proportional to the characteristic of the sample.

6. The device of claim 1, wherein the microfluidic layer augments a concentration of an analyte including the characteristic of the sample in the microfluidic channel.

7. The device of claim 1, wherein the microfluidic layer includes a plurality of microfluidic channels and the at least one light source generates a plurality of illuminating light beams, the device further comprising an optical element that directs each one of the plurality of illuminating light beams to at least one microfluidic channel from the plurality of microfluidic channels and thereby generates a plurality of sample interacted lights.

8. The device of claim 7, wherein the ICE layer further includes:
a second ICE core to generate a second modified light from a sample interacted light coming from a second microfluidic channel from the plurality of microfluidic channels.

9. The device of claim 7, wherein the at least one light source provides a plurality of illuminating light beams, each light beam having a selected wavelength.

10. The device of claim 7, wherein the at least one light source provides a plurality of illuminating light beams, each light beam being pulsed at a selected time interval.

11. The device of claim 7, wherein a detector in the detector layer collects a signal from a sum of the plurality of sample interacted lights.

12. A method of measuring a characteristic of a sample fluid, comprising:
injecting the sample fluid into a microfluidic layer;
providing an illuminating light to at least one microfluidic channel in the microfluidic layer;
interacting the illuminating light with an integrated computational element (ICE) arranged in an ICE layer and with the sample fluid to form interacted light;
directing the interacted light to a detector; and
determining a value for a characteristic of the sample fluid based on a detector signal generated by the detector.

13. The method of claim 12, further including modifying a borehole operation based on the value determined for the characteristic of the sample fluid.

14. The method of claim 12, wherein injecting the sample fluid into the microfluidic layer includes injecting a drilling mud into the at least one microfluidic channel, the characteristic of the sample fluid being indicative of an additive suspended in the drilling mud.

15. The method of claim 12, wherein injecting the sample fluid into the microfluidic layer includes injecting at least one of a solvent or a reagent into the microfluidic layer.

16. The method of claim 12, wherein injecting the sample fluid into the microfluidic layer further includes:
injecting the sample fluid into at least two microfluidic channels;
providing a first illuminating light to a first one of the at least two microfluidic channels; and
providing a second illuminating light to a second one of the at least two microfluidic channels.

17. The method of claim 12, wherein determining the value for the characteristic of the sample fluid includes measuring at least one of a color of the sample fluid, a C₁-C₅ content in the sample fluid, a saturates, aromatics, resins, and asphaltenes content in the sample fluid, a CO₂ content in the sample fluid, and an H₂S content in the sample fluid.

18. The method of claim 12, wherein determining the value for the characteristic of the sample fluid includes measuring a bacterial kill ratio in a production fluid of a borehole operation.

19. The method of claim 12, further including modifying a borehole operation based on the value for the characteristic of the sample fluid.

20. The method of claim 19, wherein modifying the borehole operation includes at least one of modifying an additive composition in a drilling fluid, modifying a drilling direction of a drill bit, or modifying a pump flow rate of the drilling fluid into a borehole.
